(19) United States
(12) Patent Application Publication
(10) Pub. No.: US 2007/0098501 A1
(43) Pub. Date: May 3, 2007

(54) IN-SITU TREATMENT OF IN GROUND CONTAMINATION

(76) Inventors: Thomas E. Higgins, Reston, VA (US); Thomas J. Simpkin, Centennial, CO (US)

Correspondence Address: PERKINS COIE LLP, POST OFFICE BOX 1208, SEATTLE, WA, 98111-1208, US

(21) Appl. No.: 11/278,009

(22) Filed: Mar. 30, 2006

Related U.S. Application Data
(60) Provisional application No. 60/732,511, filed on Nov. 2, 2005.

(51) Int. Cl. B09C 1/00

(52) U.S. Cl. 405/128.1

(57) ABSTRACT

In systems and methods for treatment of underground contamination, ferrous sulfide is provided as a substantially insoluble material in an underground formation. The ferrous sulfide accordingly may remain substantially in place, even over long periods of time, regardless of underground water movement or diffusion. As a result, the ferrous sulfide may act continuously to chemically reduce and remove contamination. When used for treatment of chromium ore processing residue contamination, the ferrous sulfide may remain in the pores of the soil or residue. As hexavalent chromium diffuses from the soil or residue, it is reduced by the ferrous sulfide. The ferrous sulfide may be injected as a liquid into the underground formation, and then change to a more solid form. Chlorinated solvent contamination, dissolved chromium from other than COPR contamination, and other dissolved metals may also be treated.

### PRIORITY CLAIM

This application claims priority to U.S. Provisional Patent Application No. 60/732,511 filed Nov. 2, 2005, and is incorporated herein by reference.

### BACKGROUND

The field of the invention is treatment of in ground contamination. For much of the twentieth century, chromite ore was processed at various locations in the United States, to manufacture chromium and related materials. Processing the chromite ore created large amounts of chromite ore processing residue (COPR). Millions of tons of COPR were then placed into the ground, often at or near the processing locations. These sites, which are now contaminated with COPR, are in or near densely populated urban and waterfront areas in United States. There are similarly contaminated sites in Europe, Japan, and other countries.

COPR is similar in texture to coarse gravel. It is formed as solid nodules or pellets generally ¼ to ½ inch in diameter, as a waste product from ore processing. These pellets were often used like gravel, as grading and fill material, and also in construction of residential, commercial and industrial buildings. COPR was also used in roadbeds and pipeline trenches. Consequently, some COPR deposits may extend for thousands of feet under dense urban development. In addition, in many of these locations, the COPR is below the ground water table.

COPR is a strong alkaline or caustic material. It typically has a pH of about 11-12. COPR typically also contains %1-%30 of hexavalent chromium, having the chemical symbol Cr(VI). Cr(VI) is toxic to humans. It can be absorbed into the body via the skin, mouth or via inhalation. It is known to cause cancer and genetic mutations. Consequently, COPR presents serious environmental and public health hazards.

Cr(VI) is also present in other types of contaminated sites, dissolved in ground water. The Cr(VI) maybe the result of releases from metals plating operations, from the application of Cr(IV) corrosion inhibitors, and from landfills or other disposal sites.

At COPR contaminated sites, the chromium is present in the solid particles as well as in the ground water in the pores or spaces between the COPR particles or pellets. Since Cr(VI) is soluble in water, if the pore water is removed, the hexavalent chromium is replaced by a slow diffusion or leaching of additional hexavalent chromium from within the particles. As a result, pump and treat or soil washing is ineffective or at least impractical for treatment of COPR sites.

Cr(VI) in pore water can be converted to trivalent chromium, which has the chemical symbol Cr(III), using remediating chemical compounds. These compounds include soluble ferrous iron salts, such as ferrous sulfate or ferrous chloride, or other similar remediating compounds. Cr(III) is insoluble and relatively non-toxic. Accordingly, if the Cr(VI) could be substantially completely converted to Cr(III), the COPR at many sites could then be safely left in the ground. However, with these chemical remediation methods, the soluble remediating compounds tend to be washed away by ground water movement relatively quickly. Consequently, the conversion process expectedly does not last long enough to clean up the site.

Other in-situ clean up processes use biological reduction of the Cr(VI), with or without use of other remediating materials. In biological clean up techniques, organic materials containing bacteria and nutrients are mixed into the COPR contaminated soil. However, in general, these types of biological reduction techniques require a pH conducive for growth of bacteria, typically about 6.5 to 9.5. Consequently, biological techniques have required adding large amounts of acid into the contaminated site, to lower the pH to a level acceptable for growth of bacteria. The acid causes destruction of the COPR particle structure. This can make future handling of the COPR more difficult. The acid also generates large volumes of carbon dioxide gas. In addition, placing large amounts of acid into the ground can damage structures on or in the ground. The disadvantages of the need for this use of acids has largely prevented effective use of biological remediation techniques on COPR.

In view of these problems, plans for permanent clean up of COPR sites have largely contemplated excavation and removal of the COPR material. This can require demolition, in-fill, and reconstruction of buildings on the contaminated sites. Moreover, the excavated material must still be remediated off site to convert the Cr(IV) to Cr(III), before it can be placed in landfill or other final disposal site. The costs, disruption, and delays associated with excavation and removal of the contaminated material can of course be enormous. Treating sites having dissolved Cr(IV) presents similar problems. Accordingly, improved methods for cleaning up COPR and dissolved Cr(IV) contaminated sites are needed.

Chlorinated solvents are more common contaminants found in groundwater throughout the United States. Chlorinated solvent contaminants include perchloroethylene (PCE), tricholoroethylene (TCE) and dichloroethylene (DCE), as well as various other halogenated aliphatic compounds and solvents. These contaminants typically have resulted from spills or leaks. Typical sites contaminated with chlorinated solvents will have the solvent dissolved in the ground water, or the solvent in an in ground bulk non-aqueous liquid phase, or both. Even relatively small amounts of solvent can pose serious risks to the environment and to water supplies.

TCE and PCE are found at more than 3,000 Department of Defense (DoD) sites in the US and 80% of all Superfund Sites. Projected life cycle costs for treatment of the DoD sites may exceed $2 billion. Chlorinated solvents are among the most difficult contaminants to remediate, particularly when they are present as Dense Non-aqueous Phase Liquids (DNAPL). DNAPLs are especially difficult to remediate because they tend to sink through the soil and groundwater system because their density is greater than water. If significant quantities have been spilled at a site, the DNAPL can continue to migrate vertically until it reaches an impermeable layer, such as a dense clay.

Another challenge with chlorinated solvents is that even a small spill can result in very large dissolved plumes. For example, one gallon of pure TCE could result in a groundwater plume greater than the drinking water standard of 5 ppb that is 90 acres and 30 ft thick. These large plumes are very difficult and expensive to treat.

Commonly used technologies for treatment of chlorinated solvents DNAPLs include excavation, thermal technologies, and containment using slurry walls. Commonly used technologies for treatment of the dissolved plume include air sparging, in situ oxidation, enhanced reductive dechlorination (bioremediation), and pump and treat. Zero valent iron has also been used for DNAPL treatment, and as a barrier for migration of dissolved plumes. The iron serves as a chemical reducing agent removing chlorine from the chlorinated solvent compounds. One of advantages of zero valent iron is that if enough is applied, it will last for a number of years and provide long term treatment. However, these methods are limited because the large particle size of the iron limits how it can be placed into the soil and groundwater systems. These methods can also require mixing or trenching of the iron into the soil. Zero valent iron has also become expensive over the past few years as the cost of iron has increased.

Iron sulfides have also been proposed as reducing agents for the dechlorination of chlorinated solvents, much in the same way that zero valent iron does. Iron sulfides have been formed by the application of a labile organic substrate with sulfate, as needed, to a soil and groundwater supply. The organic substrate stimulates the reduction of sulfate to mineral iron sulfides, which abotically treat chlorinated solvents and hexavalent chromium.

However, achieving practical methods for the large scale production and delivery of ferrous sulfide needed has been technically challenging.

Accordingly, improved systems and methods for treatment of contamination are needed.

### SUMMARY OF THE INVENTION

In a first aspect, in a method for treatment of dissolved chromium or COPR, ferrous sulfide is provided as a substantially insoluble reducing compound material in the pores of the COPR or soil. The ferrous sulfide accordingly substantially remains in place and is not washed out by water movement or diffusion. Accordingly, the ferrous sulfide is available when hexavalent chromium diffuses from the COPR. Ferrous sulfide may advantageously initially be applied as solutions of ferrous and sulfide salts, which can be injected separately into the COPR formation, and then combine to form a solid. In liquid form, the reducing salts are easier to apply into the ground. The distribution throughout the pores may also better in comparison to applying a reducing compound in a solid form.

In a second aspect of the invention, in a method for treatment of chlorinated solvents, dissolved hexavalent chromium, and similar contaminants, ferrous sulfide is provided as a substantially insoluble material in soil pores. The ferrous sulfide substantially remains in place and is not washed out by water movement or diffusion. Accordingly, the ferrous sulfide is available when chlorinated solvents diffuse out from dense non-aqueous phase liquids or from up-gradient solvent sources. The ferrous sulfide may initially be a liquid or solution, which can be injected into the formation, and then change to a more solid form. It may alternatively be provided as a slurry.

Other objects, features and advantages will become apparent from the following description. The invention resides as well in sub-combinations of the steps and elements described. The steps and elements essential to the invention are described in the claims, other steps and elements being not necessarily essential.

### DETAILED DESCRIPTION

In general, for treatment of COPR, the reducing compound should be effective at reducing hexavalent chromium at a pH of about 8-13, and typically about 10, 11, 12, or 13, so that the alkalinity of the COPR does not need to be neutralized. This avoids the need to add large amounts of acid to lower the pH. The reducing compound advantageously generally does not excessively promote the formation of minerals that can result in the swelling of the COPR. The reducing compound is also preferably capable of remaining in the pores for at least 6, 9 or 12 months, or longer, without loss of effectiveness, even with movement of ground water. At some sites, it may be necessary or advantages to have the reducing compound remain in place for several years.

In one embodiment, a ferrous salt solution and a sulfide salt solution (such as ferrous sulfate and sodium sulfide provided as liquid precursors) are dispersed into the COPR or chlorinated solvent contaminated zone. The ferrous ions combine with the sulfide ions to form a colloidal precipitate of ferrous sulfide. Since the ferrous sulfide particles form in the injection system piping or in the soil, they are small (colloidal) and hence easy to mix completely with COPR and surrounding soil pores. The ferrous sulfide may be completely solidified while still in the injection system, so that already solid ferrous sulfide particles are placed in the ground. Ferrous sulfide particles may alternatively be delivered in bulk to the site, in solid or slurry form. In the treatment of chlorinated solvents or dissolved Cr(IV), the ferrous sulfide particles are similarly small and easy to distribute in the subsurface. Particles with a size of less than about 5, 4, 3, 2 and more often 1 micron (mean diameter) are generally more effectively injected in an aqueous liquid, in comparison to larger size particles. The FeS particles are consequently formed with an intended particle size of 1 micron or less.

The ferrous sulfide reacts with hexavalent chromium in solution converting the chromium to the trivalent form, which precipitates as a hydroxide. The ferrous iron is oxidized and forms ferric hydroxide precipitate. The sulfide is oxidized to elemental sulfur. For the treatment of treatment of solvents such as TCE or PCE, the ferrous sulfide reduces the chlorinated solvents abiotically with acetylene as the major reaction product. The low solubility of ferrous sulfide helps to prevent it from being washed out of the system by groundwater movements. Ferrous sulfate may be used with or instead of ferrous chloride.

The result of these reactions is the in situ lowering of the hexavalent chromium in the water surrounding the COPR. Additional hexavalent chromium will dissolve and diffuse from inside the COPR particles to the particle surfaces, where it will react with the solid ferrous sulfide particles. In addition, the ferrous sulfide solids will partially dissolve releasing molecules of ferrous sulfide which penetrate the COPR particles and react with dissolved Cr(VI) in the COPR. Due to the low solubility of ferrous sulfide only a small portion of the ferrous sulfide is dissolved as needed for the Cr(VI) reaction. Hence the solid will remain for a long time, unless needed for reduction of the Cr(VI). Sufficient ferrous sulfide particles are provided to treat the hexavalent chromium and/or chlorinated solvent(s) over a period of months or years to a desired remediation standard. The methods described may be used to remediate dissolved oxidized metals including hexavalent chromium, as well as chlorinated solvents such as PCE, TCE, cis 1,2 DCE, vinyl chloride, TCA, PCA, or DCA.

The ferrous sulfide may be generated by the mixing of a ferrous salt solution with a solution of sodium sulfide (above ground or in injection system piping) by the following reaction:
FeCl₂+Na₂S->FeS(s)+2Na⁺+2Cl⁻.

The resulting precipitate of ferrous sulfide tends to form rapidly. Consequently, the ferrous sulfide may solidify completely into particles, before it is placed in the ground. The ferrous sulfide generally will first form a neutral molecule of ferrous sulfide, followed by growth to colloidal and larger particles of ferrous sulfide. This makes it easier to inject and distribute throughout the COPR if the ferrous sulfide is freshly precipitated when compared to a solid that has to be reduced in size and injected as a slurry. Additives such as surfactants, detergents, and phosphates may be used. Precipitation slowing additives may also be used to slow down formation of solid ferrous sulfide.

The FeS is advantageously formed as a solid either in the pores of the COPR or in the pore space between individual COPR particles, or in the equipment used to mix and inject the chemicals into the COPR formation. If formed on the outside of the pores, it is preferably pushed uniformly throughout the pores of the COPR or the subsurface. Excess ferrous sulfide is advantageously added to account for oxidation by air, insufficient mixing, or other losses.

Ferrous sulfide reacts with hexavalent chromium (represented as chromate) by the following reaction:
CrO₄⁻²+FeS+2H₂O+2H⁺->Fe(OH)₃+S+Cr(OH)₃

Iron and chromium are converted to their trivalent form and precipitate as hydroxides. Sulfide is oxidized to elemental sulfur (not sulfate). This helps to avoid swelling, which appears to be associated with mixing sulfate salts with COPR.

For stoichiometric reaction, for each gram of hexavalent chromium (as Cr) need to add 1.08 grams of ferrous chloride (as Fe) plus 1.5 grams of sodium sulfide (as Na₂S). Therefore add 3 times stoichiometric of 3.24 g of ferrous chloride or ferrous sulfate (as Fe) plus 4.5 g of Na₂S for each gram of hexavalent chromium. An FeS concentration greater than 3 times this stoichiometric dose may be needed to provide good results. Commercial solutions of ferrous sulfate and ferrous chloride may be used, as these contain acid in addition to the salt. These materials are the byproduct of acid pickling of steel. Accordingly, they are economically available in large quantities. To minimize corrosion to chemical delivery equipment, the excess acid may be neutralized with an alkaline compound such as sodium hydroxide before injection.

Although the concentrations of the reducing compounds may of course be varied for specific applications, the following guidelines may be used.

Ferrous Chloride: 9 to 14% solution (as Fe) liquid technical grade

Ferrous Sulfate: 5 to 7% solution (as Fe) liquid technical grade

Sodium Sulfide: 10 to 30% solution (make from dry chemical)

The measurement of acceptable remediation of Cr(IV) may vary depending on the characteristics, location, and regulation of each specific contaminated site. A reduction of Cr(IV) to concentrations of 240 to 20 mg/kg, or less, may be required, representing reduction of 95% to 99.5% or more of the initial concentration of Cr(VI) in the contaminated soil or COPR.

The ferrous sulfide may be injected or placed by pumping solutions of the two chemical separately with precipitation occurring in the ground. When injected as a liquid, the reducing compound may be placed into the ground with a hydro-punch or pipe, or with injection wells, or using direct push methods. In a typical application, a 1-4 inch diameter pipe is driven into position and then the liquid is pumped in or injected. Injection times at each punch or placement may vary, with 5-90 minutes being typical. The pipe is then moved over to the next designated position. This procedure can repeated, in a grid, spiral, or other pattern, until the entire site has been injected. Slant injection may also be used to place the liquid or slurry reducing compound under in or on ground structures, or to reach positions not easily directly accessible from vertically above. Hydraulic or pneumatic fracturing methods may also be used, optionally in combined fracturing/injection methods to deliver a slurry containing ferrous sulfide particles to the in ground formation. Fracturing has the potential for improving delivery of the FeS into low permeability formations. Permeability of fractured formations may be dramatically increased, depending on the site conditions.

With injection methods for treatment of COPR, the FeS particles may be formed by mixing of the FeCl₂ and the Na₂S solutions into the injection equipment. Separate metering pumps may be used for each component, with the solutions passing through an in line mixer before injection. Since the reaction between the Fe²⁺ and the S²⁻ is very rapid, small particles may be created. Deflocculating and/or sequestering agents, such as polyphosphate, non-ionic detergent, or silicone-based dispersing agents may be added to help keep the FeS particles dispersed as they are delivered into the underground matrix. Since the FeS is practically insoluble in water, emulsified vegetable oil may be used as a transport medium to disperse the FeS through the COPR. Caustics may be added to neutralize the excess acids of the ferrous salt before injection.

While it may not be necessary in most applications, the reducing compound may also be placed in permanent, or semi-permanent wells or well pipes. While most COPR deposits are below the water table, the present methods may also be used in COPR deposits above the water table. Similarly, these methods may be used to clean up Cr(VI) contamination other than from COPR sites, or chlorinated solvents, above or below the water table. In the case of COPR, since the reducing compound will generally be mixed with a solution containing water before or as it is placed into the COPR deposits, the pores between the pellets will become filled with the ferrous sulfide containing liquid even above the water table. Regardless of the type of contamination to be treated, the ferrous salt, or the sulfide salt, or both, may also be added to the soil as dry salts. Water in the ground (natural groundwater or water pumped into the ground) may then mix with the salt(s) in the ground. The salt(s) dissolve in the water, mix together and chemically react to form solid ferrous sulfide.

In augering applications, conventional or hollow stem augers may be used. With augering, the reducing compound may be a solid, a liquid or a slurry. Alternatively, components can be mixed in-line before injection or mixed and injected using an auger soil mixer. Other methods of mechanically mixing the soil with ferrous sulfide or ferrous sulfide precursors may be used, including plowing, rototilling, and soil excavation followed by above ground mixing and then mixed soil replacement.

Testing was conducted on chromite ore processing residue (COPR). Several columns were prepared to evaluate COPR chromium reduction with various concentrations of sulfide along with either ferrous chloride or ferrous sulfate. The columns were prepared in the following manner:

1. Column material consists of 6-inch clear PVC pipe with white PVC end caps.

2. The bottom end cap included a ½ inch plastic valve for sampling the liquid phase of the column, and was sealed using PVC glue.

3. The top end cap included two ¼ inch barbed fittings for filling and venting during set up and sampling, and was sealed with an inert silicone based vacuum grease, allowing the top to be removed for solids sampling.

4. Approximately 1-inch of geotextile material and approximately 4-inches of 0.2-mm quartz sand were added to the base of the column to support the COPR material, and allow water to drain freely.

5. Deionized water was added to the columns to determine the pore volume contained in the geotextile material and sand. This volume was determined to be 900-ml. Two of these pore volumes will be removed from the column before liquid samples are taken, which will represent the liquid portion surrounding the COPR.

6. The COPR material was screened using a 0.5-inch sieve.

7. The stoichiometric amount of sodium sulfide was determined from the Cr-VI concentration in the COPR. The sodium sulfide solid material was weighed on an analytical balance and dissolved in 1-liter of deionized water.

8. The amount of iron product was determined based on the sulfide and Cr-VI concentrations. Analytical grade ferrous chloride (powder hydrated with deionized water) was used for column 1 (C1), and technical grade ferrous chloride and ferrous sulfate liquid material was used for the other columns.

9. The appropriate amount of screened COPR was placed in a 2-gallon disposable plastic bucket and placed in a laboratory fume hood.

10. 1-liter of site groundwater was added to the COPR first, to create a slurry.

11. ⅓ of the sulfide was added, mixed well, and then followed with ⅓ of the ferrous iron and additional mixing. This process was continued until all the treatment chemicals were added.

12. The COPR with treatment chemicals was then added to the test columns.

13. The top end cap was sealed with vacuum grease and placed on the column. Groundwater was added to fill the column and eliminate headspace.

14. Table 1 summarizes the conditions used for each of the column tests.

15. Sampling was started by allowing 1,800-ml to flow from the column first. This represents two times the void volume contained in the geotextile material and sand at the base of the column. After this portion is removed, samples that represent the liquid contained in the COPR material is collected for testing.

16. After the water samples are collected the top caps are removed for solids sampling. A core device is used to collect a top-to-bottom column of COPR material for testing.

17. After sampling the top cap was replaced, and the initial pore water was returned to the column, along with additional groundwater to eliminate headspace.

18. Analytical data for samples taken during the first 72 days following chemical addition are presented in tables 2 and 3. Table 2 shows the pore water hexavalent chromium concentrations. Table 3 shows the hexavalent chromium in the solid COPR.

19. All doses of ferrous iron and sulfide reduced the pore water concentration of hexavalent chromium in the pore water and in the COPR solids within a 2 month period.

TABLE 1
Column Dose Calculations

| | | Dose for Each Column | | | | |
|---|---|---|---|---|---|---|
| Parameter | Units | C1 | C2 | C3 | C4 | C5 |
| COPR amount | Kg | 5.0 | 5.0 | 4.0 | 4.0 | 4.0 |
| COPR Cr-VI | g/Kg | 3.41 | 3.41 | 3.41 | 3.41 | 3.41 |
| COPR Cr-VI | g | 17.05 | 17.05 | 13.64 | 13.64 | 13.64 |
| COPR Cr-VI | moles | 0.33 | 0.33 | 0.26 | 0.26 | 0.26 |
| Na₂S*9H₂O (˜100%) | g | 472 | | | | |
| Sulfide, as S | g | 63 | | | | |
| Sulfide, as S | moles | 1.97 | | | | |
| Na₂S (60%) | g | | 182 | 146 | 152 | 101 |
| Sulfide, as S | g | | 44.8 | 35.9 | 37.4 | 24.9 |
| Sulfide, as S | moles | | 1.4 | 1.12 | 1.16 | 0.77 |
| FeCl₂*4H₂O (reagent) | g | 389 | | | | |
| Fe²⁺ | g | 109 | | | | |
| Fe²⁺ | moles | 1.96 | | | | |
| Ferrous Chloride (Kemiron) | | | | | | |
| 10.46% Fe²⁺ | g | | 2,107 | | 530 | 350 |
| Fe²⁺ | g | | 220 | | 55 | 37 |
| Fe²⁺ | moles | | 3.95 | | 0.99 | 0.66 |
| Ferrous Sulfate (Kemiron) | | | | | | |
| 5.20% Fe²⁺ | g | | | 3,379 | | |
| Fe²⁺ | g | | | 176 | | |
| Fe²⁺ | moles | | | 3.15 | | |
| Sulfide:Cr-VI ratio as S:Cr | mole/mole | 6.0 | 4.2 | 4.3 | 4.5 | 3.0 |
| Iron:Cr-VI ratio as Fe²⁺:Cr | mole/mole | 6.0 | 12.0 | 12.0 | 3.8 | 2.5 |

TABLE 2
COPR FeS Column Test Results - Water

| Reaction | Cr-VI (ug/L) | | | | |
|---|---|---|---|---|---|
| Time (days) | C1 | C2 | C3 | C4 | C5 |
| 0 | 2,650 | 2,650 | 2,650 | 2,650 | 2,650 |
| 5 | — | <1 | <1 | — | — |
| 14 | <1 | — | — | 8.44 | 9.02 |
| 42 | — | — | — | — | — |
| 46 | — | — | — | ND | ND |
| 68 | — | ND | ˜7 | — | — |
| 77 | ˜7 | — | — | — | — |

TABLE 3
COPR FeS Column Test Results - Solids

| Reaction Time | Cr-VI (mg/Kg) | | | | |
|---|---|---|---|---|---|
| (days) | C1 | C2 | C3 | C4 | C5 |
| 0 | 3,410 | 3,410 | 3,410 | 3,410 | 3,410 |
| 12 | — | <0.010 | <0.019 | — | — |
| 14 | — | — | — | 0.30 | <0.11 |
| 21 | 0.13 | — | — | — | — |
| 42 | — | — | — | — | — |
| 46 | — | — | — | 0.11 | 0.42 |
| 68 | — | <0.053 | <0.065 | — | — |
| 77 | 0.42 | — | — | — | — |

As used here, the singular includes the plural and vice versa, unless specifically excluded by the context. The word “or” as used here means either one, or any one, both, or all of the listed items, and does not mean an alternative qualitatively different element, or a non-equivalent element. The systems and methods described may be used for clean up of dissolved hexavalent chromium, or other metals, from virtually any source, including non-COPR sources, as well as for various other types of organic contaminants, including chlorinated and other solvents. The elements or steps described relative to one embodiment apply as well to other embodiments, except when otherwise specified.

Thus, novel methods and systems have been described. Various changes and modifications may of course be made without departing from the spirit and scope of the invention. The invention, therefore, should not be limited, except to the following claims and their equivalents.

1. A method for reducing contamination of soil and ground water, comprising:
providing ferrous sulfide in the ground, with the ferrous sulfide remaining substantially in place in the ground, and with the ferrous sulfide reducing contamination of the ground water.

2. The method of claim 1 with the ferrous sulfide formed from a ferrous salt solution and a sulfide salt solution each provided as a liquid precursor and further including injecting the liquid precursors into the ground, with the liquid precursors combing to form ferrous sulfide solids in the ground.

3. The method of claim 1 wherein the ferrous sulfide is generated by mixing a ferrous salt solution and a sulfide salt solution either above ground or in the injection piping.

4. The method of claim 3 wherein the ferrous salt comprises ferrous sulfate and the sulfide salt comprises sodium sulfide.

5. The method of claim 3 wherein the ferrous salt comprises ferrous chloride and the sulfide salt comprises sodium sulfide.

6. The method of claim 1 where the ferrous sulfide is provided via a hydro-punch, pipe, or direct push methods.

7. The method of claim 1 with the ferrous sulfide placed in one or more well pipes.

8. The method of claim 1 with the ferrous sulfide placed via mechanical mixing.

9. The method of claim 8 wherein the mechanical mixing is performed by augering, plowing, rototilling and/or soil excavation, mixing and replacement.

10. The method of claim 1 where the contamination comprises chromium ore processing residue.

11. The method of claim 1 where the contamination comprises a chlorinated solvent.

12. The method of claim 11 wherein the chlorinated solvent comprises PCE, TCE, cis 1,2 DCE, vinyl chloride, TCA, PCA, or DCA.

13. The method of claim 1 where the contamination comprises one or more dissolved oxidized metals.

14. The method of claim 13 wherein the dissolved oxidized metal comprises hexavalent chromium.

15. The method of claim 2 further comprising adding a surfactant, a detergent, a phosphate or a precipitation slowing agent to the liquids.

16. An underground formation comprising:
at least one contaminant;
ground water associated with the contaminant; and
an at least partially solidified ferrous sulfide distributed in the contaminant from an above ground ferrous sulfide placement apparatus.

17. The formation of claim 16 wherein the contaminant comprises a chlorinated solvent, dissolved hexavalent chromium or COPR.

18. The formation of claim 17 wherein the ferrous sulfide is formed in the ground by injecting a ferrous salt solution and a sulfide solution into the ground.

19. The formation of claim 16 further including a plurality of ground injection locations formed in repeating pattern.

20. A system for treatment of underground contamination, comprising:
a ferrous salt solution source;
a sulfide salt solution source;
a pump connected directly or indirectly to the ferrous salt solution source, and to the sulfide salt solution source; and
a ground injection line connecting to the pump.

21. The method of claim 1 wherein the ferrous sulfide is provided by combining a ferrous salt and a sulfide salt in the presence of water, and with one or both of the salts provided in the ground as a dry salt.
